(19) United States
(12) Patent Application Publication
(10) Pub. No.: US 2014/0161509 A1
(43) Pub. Date: Jun. 12, 2014

(54) DRIVE SHAFT

(71) Applicants: HYUNDAI MOTOR COMPANY, Seoul (KR); DAE SEUNG CO., LTD., Pyeongtaek (KR)

(72) Inventors: Won Jun Choi, Busan (KR); Tae Youl Kim, Suwon (KR); Moon Mo Kang, Osan (KR)

(73) Assignees: Dae Seung Co., Ltd., Pyeongtaek (KR); Hyundai Motor Company, Seoul (KR)

(21) Appl. No.: 13/830,369

(22) Filed: Mar. 14, 2013

(30) Foreign Application Priority Data
Dec. 12, 2012 (KR) 10-2012-0144945

(51) Int. Cl. F16D 1/02

(52) U.S. Cl. CPC F16D 1/02
USPC 403/2

(57) ABSTRACT

Disclosed is a drive shaft that includes a first rotary shaft having a plurality of locking projections for a spline engagement formed along an outer circumferential surface of the end portion of the first rotary shaft. The driveshaft further includes a secondary rotary shaft having a plurality of locking grooves for the spline engagement corresponding to the locking projections, which are formed on the inner circumferential surface into which the first rotary shaft are inserted. Additionally, the driveshaft includes fixing members fitted on the outer circumference of the first rotary shaft and fixing apertures which are formed through the outer circumference of the first rotary shaft or the inner circumference of the second rotary shaft to correspond to the fixing members and into which the fixing members are fitted.

### CROSS-REFERENCE TO RELATED APPLICATION

This application claims under 35 U.S.C. §119(a) the benefit of Korean Patent Application No. 10-2012-0144945 filed on Dec. 12, 2012, the entire contents of which are incorporated herein by reference.

### BACKGROUND

(a) Technical Field

The present invention relates to a drive shaft that absorbs a shock without being deformed axially during a vehicle collision.

(b) Background Art

In general, a driveshaft is a part of a powertrain which is used in RWD (Rear Wheel Drive) vehicles or 4WD (4 Wheel Drive) vehicles, wherein engine power is transmitted to the rear wheels. A driveshaft is not generally used in FWD (Front Wheel Drive) vehicles or RR (Rear Engine Rear Wheel Drive) vehicles because the engine and the wheels are disposed closer together than in the RWD and 4WD designs, and transmits power from the engine to a final reduction gear system at the front or rear part of the vehicles.

The conventional driveshaft is composed of various parts, including a center bearing and a yoke, in addition to a universal joint to maintain substantially smooth transmission of a driving force despite a change in relative position of the front and rear parts of a vehicle, and may be designed to have torsional strength against torsion due to substantially large rotational force to transmit torque, and sufficient flexural rigidity due to the axial length.

Recently, design importance of drive shafts has increased as the demand for passenger safety during a vehicle collision of a vehicle increases due to safety regulations. In particular, a powertrain including an engine, a transmission, etc. moves rearward in front/rear vehicle collisions, then excessive momentum and shock energy which are generated by the collisions are fully transmitted to the vehicle body through the driveshaft, causing shock applied to the vehicle body.

FIG. 1 is an exemplary view showing a driveshaft according to the related art, in which a tube 10 is partially narrowed and the neck 20 deforms in a collision. However, the manufacturing process of the neck 20 may be limited due to the properties of the material used for tube 10. Further, in the conventional driveshaft, the tube may not sufficiently deform in a collision, thereby causing an increase in shock transmitted to the vehicle body. Thus, the diameter of the tube may need to be increased, however an increase in diameter of the tube may increase the weight of the driveshaft.

The description provided above as a related art of the present invention is just for helping understanding the background of the present invention and should not be construed as being included in the related art known by those skilled in the art.

### SUMMARY

The present invention provides a drive shaft that may reduce shock transmitted to a vehicle body by absorbing shock generated by a vehicle collision, and changing the axial length in a collision of a vehicle, thus decreasing an impulsive force transmitted to a passenger.

The drive shaft of the present invention may include: a first rotary shaft having a plurality of locking projections for a spline engagement formed along an outer circumferential surface of the end portion; a secondary rotary shaft having a plurality of locking grooves for the spline engagement corresponding to the locking projections, which are formed on the inner circumferential surface into which the first rotary shaft may be inserted; one or more fixing members fitted on the outer circumference of the first rotary shaft or the inner circumference of the second rotary shaft; and one or more fixing apertures formed through the outer circumference of the first rotary shaft or the inner circumference of the second rotary shaft to correspond to the fixing members and into which the fixing members are fitted wherein the first rotary shaft and the second rotary shaft are prevented from sliding by fitting the fixing members into the fixing apertures under normal condition (e.g., when the vehicle operates without a collision), and when load is applied by a vehicle collision, the fixing members break, which allows the first rotary shaft and the second rotary shaft to slide apart.

The fixing members may be mounted on a fixing ring disposed between the outer circumference of the first rotary shaft and the inner circumference of the second rotary shaft. The fixing ring may have a ring-shaped base and a plurality of insertions protruding with predetermined intervals along the circumference of the base. A support groove and a mount groove facing each other may be formed on the outer circumference of the first rotary shaft and the inner circumference of the second rotary shaft, respectively, and the fixing ring may be disposed between the support groove and the mount groove.

The fixing apertures may be formed through the circumference toward the center of the shaft and the fixing ring may be made of synthetic resin injected into the fixing apertures. The fixing members may be fixing pins fitted to the first rotary shaft through the second rotary shaft. The mount apertures may be formed on the outer circumference of the first rotary shaft, the fixing apertures may be formed axially through the second rotary shaft to correspond to the mount apertures, and the fixing pins may be inserted into the mount apertures and the fixing apertures.

Furthermore, the driveshaft may include a plurality of the fixing members having a fixing ring disposed between the outer circumference of the first rotary shaft and the inner circumference of the second rotary shaft and a plurality of fixing pins fitted to the first rotary shaft through the second rotary shaft. The fixing member may be made of a light material and may be configured to break when a predetermined amount of load is applied due to a vehicle collision. The locking protrusions of the first rotary shaft and the locking grooves of the second rotary shaft may be formed in the shape of an involute gear which correspond to each other. The second rotary shaft may have a bar-shaped shaft body and a hub having a plurality of locking grooves that mesh with the locking protrusions, on the inner circumference of an end portion of the shaft body.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view showing a drive shaft according to the related art;

FIG. 2 is an exemplary view showing a drive shaft according to an exemplary embodiment of the present invention;

FIG. 3 is an exemplary view of the drive shaft shown in FIG. 2 according to an exemplary embodiment of the present invention;

FIG. 4 is an exemplary view showing the amount of compression of the drive shaft before/after a collision according to an exemplary embodiment of the present invention;

FIG. 5 is an exemplary view showing a drive shaft according to an exemplary embodiment of the present invention;

FIG. 6 is an exemplary view showing a first rotary shaft of the drive shaft shown in FIG. 5 according to an exemplary embodiment of the present invention;

FIG. 7 is an exemplary view showing a second rotary shaft of the drive shaft shown in FIG. 5 according to an exemplary embodiment of the present invention;

FIG. 8 is an exemplary view showing a fixing member of the drive shaft shown in FIG. 5 according to an exemplary embodiment of the present invention;

FIG. 9 is an exemplary view showing a drive shaft according to another exemplary embodiment of the present invention; and

FIG. 10 is an exemplary view showing a drive shaft according to another embodiment of the present invention.

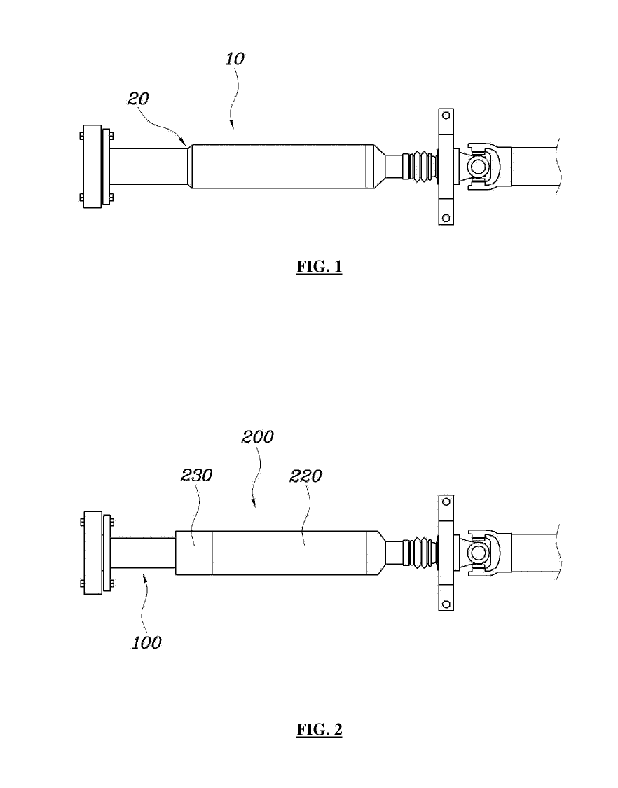

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

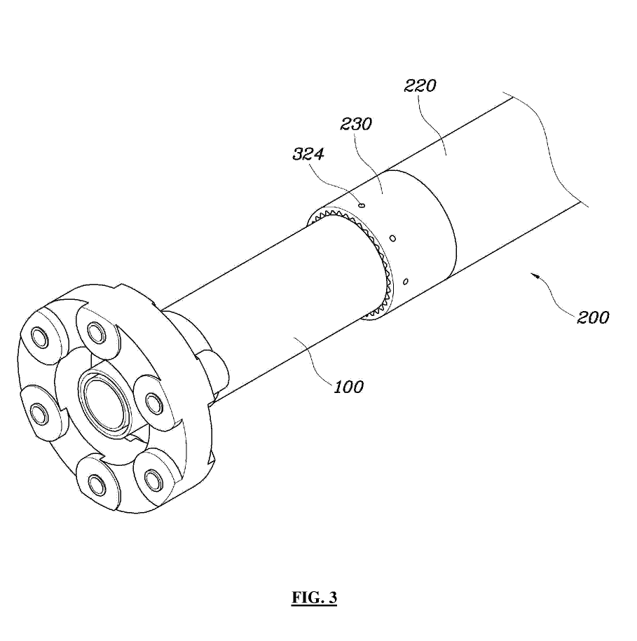

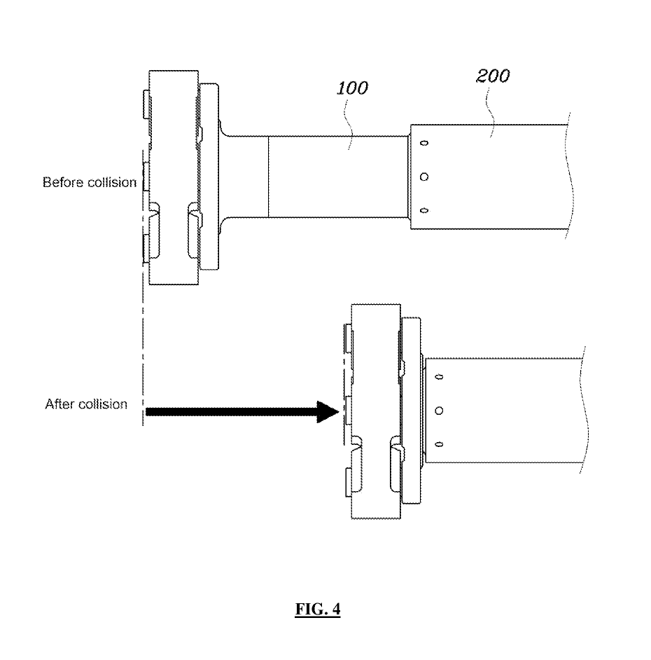

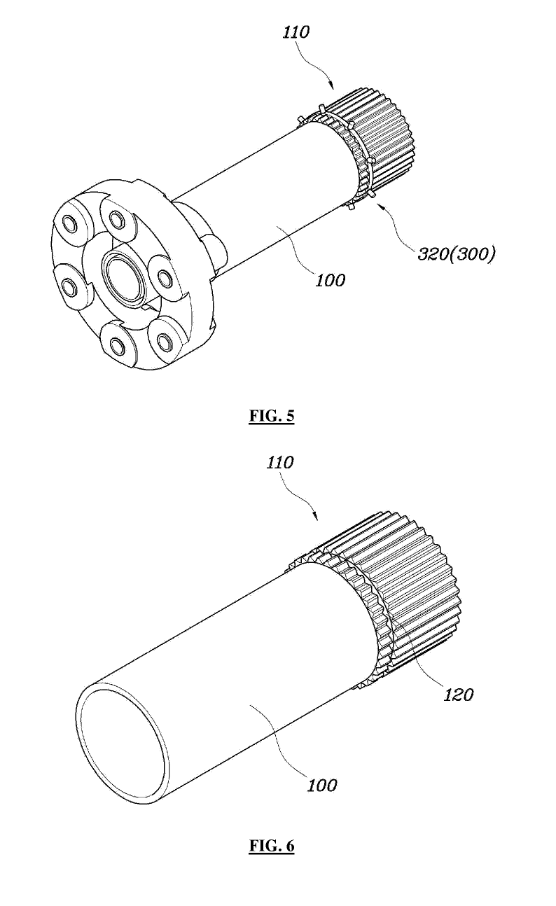

A driveshaft according to an embodiment of the present invention is described hereafter with reference to the accompanying drawings. FIG. 2 is an exemplary view showing a drive shaft, FIG. 3 is an exemplary view of the driveshaft shown in FIG. 2, and FIG. 4 is an exemplary view showing the amount of compression of the drive shaft before/after a collision. FIG. 5 is an exemplary view showing a drive shaft, FIG. 6 is an exemplary view showing a first rotary shaft of the drive shaft shown in FIG. 5, and FIG. 7 is an exemplary view showing a second rotary shaft of the driveshaft shown in FIG. 5.

A drive shaft of the present invention may include: a first rotary shaft 100 having a plurality of locking projections 110 for a spline engagement formed along an outer circumferential surface of an end portion of the first rotary shaft 100; a secondary rotary shaft 200 having a plurality of locking grooves 210 for the spline engagement corresponding to the locking projections 110, which are formed on the inner circumferential surface into which the first rotary shaft 100 is inserted; one or more fixing members 300 fitted on the outer circumference of the first rotary shaft 100 or the inner circumference of the second rotary shaft 200; and one or more fixing apertures 400 formed through the outer circumference of the first rotary shaft 100 or the inner circumference of the second rotary shaft 200 to correspond to the fixing members 300 and into which the fixing members may be fitted wherein the first rotary shaft 100 and the second rotary shaft 200 may be prevented from sliding apart by fitting the fixing members 300 into the fixing apertures 400 under normal condition (e.g., when the vehicle has not collided), and when load is applied thereto by a vehicle collision, the fixing members 300 may break, which allows the first rotary shaft 100 and the second rotary shaft 200 to slide apart.

In the present invention, the shaft transmitting power may be divided into the first rotary shaft 100 and the second rotary shaft 200, and the first rotary shaft 100 and the second rotary shaft 200 may be engaged by splines to be rotated together by power transmitted from an engine through a transmission. Further, the fixing members 300 or the fixing apertures 400 may be formed on the first rotary shaft 100 or the second rotary shaft 200 and the respective fixing members and the fixing apertures may be fitted to each other to prevent movement of the first rotary shaft 100 and the second rotary shaft 200. Furthermore, the fixing members may be broken to allow the first rotary shaft 100 and the second rotary shaft 200 to axially move apart, when a predetermined amount of shock is applied thereto by a vehicle collision.

Describing the present invention in detail, a plurality of fixing protrusions 110 may be formed on the outer circumference of the first rotary shaft 100 and a plurality of locking grooves 210 may be formed on the inner circumference of the second rotary shaft 200 to allow the first rotary shaft 100 and the second rotary shaft 200 to be mesh engaged by splines. In other words, the first rotary shaft 100 and the second rotary shaft 200 may be engaged by the locking protrusions 110 and the locking grooves 210 that correspond to each other thereby allowing the first rotary shaft 100 and the second rotary shaft 200 to rotate together, when a rotational force generated from an engine is transmitted. In particular, the shaft may be divided into the first rotary shaft 100 and the second rotary shaft 200, however the first and the second rotary shafts may rotate together by spline engagement to transmit a rotational force generated from an engine without a loss.

The first rotary shaft 100 and the second rotary shaft 200 may be configured to rotate together while transmitting a rotational force from an engine and may simultaneously axially slide apart to reduce shock transmitted to the vehicle body in a collision. However, it is necessary to prevent loss and friction in transmission of power by preventing the shafts from sliding apart during vehicle operation. Thus, the fixing members 300 and the fixing apertures 400 may formed correspondingly on the first rotary shaft 100 and the second rotary shaft 200 to be fitted to each other for preventing the sliding.

The structures of the fixing members 300 and the fixing apertures 400 may be applied to any of the first rotary shaft 100 and the second rotary shaft 200. In other words, the fixing members 300 may be formed at the first rotary shaft 100 and the fixing apertures 400 may be formed at the second rotary shaft 200, and alternatively the fixing members 300 may be formed at the second rotary shaft 200 and the fixing apertures 400 may be formed at the first rotary shaft 100.

Specifically, the fixing members 300 and the fixing apertures 400 formed on the first rotary shaft 100 and the second rotary shaft 200 may be fitted to each other and may prevent the first rotary shaft 100 and the second rotary shaft 200 from sliding apart. However, the axial lengths of the first rotary shaft 100 and the second rotary shaft 200 may vary to sufficiently absorb excessive momentum and shock energy of a power train which are generated in front/rear vehicle collisions. Therefore, when a shock is applied to the shaft due to a vehicle collision, the fixing members 300 may break and may separate from the fixing apertures 400 to allow the first rotary shaft 100 and the second rotary shaft 200 to move to vary the axial length.

In the operation of the present invention, FIG. 4 is an exemplary view showing the amount of compression of the driveshaft before/after a vehicle collision, in which the first rotary shaft 100 and the second shaft 200 that are engaged are restricted from moving axially by the fixing members 300 and the fixing apertures 400 before the vehicle collision. Furthermore, after the collision, the fixing members 300 that fix the first rotary shaft 100 and the second rotary shaft 200 may break and the first rotary shaft 100 may be inserted into the second rotary shaft 200. As described above, as the first rotary shaft 100 is inserted into the second rotary shaft 200 in a vehicle collision, the axial length of the drive shaft may be varied sufficiently to absorb a shock due to the collision. The driveshaft may be used for various types of vehicles, due to the amount of axial deformation of the drive shaft that may be controlled by adjusting the length of the first rotary shaft 100 which is inserted into the second rotary shaft 200.

In other words, according to the present invention, since the first rotary shaft 100 and the second rotary shaft 200 are engaged by splines to rotate together, it may be possible to transmit a rotational force generated from an engine without a loss. Further, since the fixing members 300 and the fixing apertures 400 that prevent the first rotary shaft 100 and the second rotary shaft 200 from being moved are separated from each other in a vehicle collision, the first rotary shaft 100 and the second rotary shaft 200 may move axially, which satisfies an advantageous condition to absorb a shock.

On the other hand, the fixing members 300 may be formed on the outer circumference of the first rotary shaft 100 and the fixing apertures 400 may be formed on the inner circumference of the second rotary shaft 200. Further, the fixing apertures 400 may be formed through the circumference toward the center of the shaft and the fixing members 300 may be formed by injecting synthetic resin into the fixing apertures 400.

As described above, the fixing members 300 may be formed on the outer circumference of the first rotary shaft 100 and the fixing apertures 400 may be formed on the inner circumference of the second rotary shaft 200 to communicate with the exterior of the drive shaft. Alternatively, the fixing hole 400 may be formed at the second rotary shaft 200 such that the fixing apertures 400 communicate with the exterior of the second rotary shaft, and the fixing members 300 may be formed by injecting synthetic resin into the fixing apertures 400 under substantially high pressure.

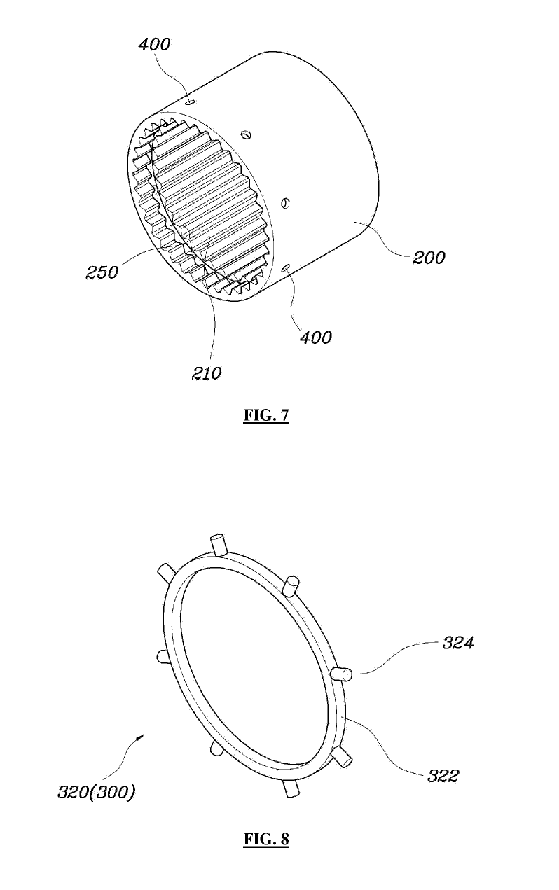

FIGS. 5 to 8 shows an exemplary embodiment configured in the way described above, in which the fixing members 300 may be mounted on a fixing ring 320 disposed between the outer circumference of the first rotary shaft 100 and the inner circumference of the second rotary shaft 200 and the fixing ring 320 may be a ring shaped base 322 and may include a plurality of insertions 324 protruding with predetermined intervals along the edge of the base 322.

Further, a support groove 120 and a mount groove 250 facing each other may be formed on the outer circumference of the first rotary shaft 100 and the inner circumference of the second rotary shaft 200, respectively, and the fixing ring 320 may be disposed between the support groove 120 and the mount groove 250.

As described above, the support groove 120 may be formed on the outer circumference of the first rotary shaft 100, the mount groove 250 may be formed at a location facing to the support groove 120 on the inner circumference of the second rotary groove 200, and the fixing member 300 may be inserted between the support groove 120 and the mount groove 250 to prevent the first rotary shaft 100 and the second rotary shaft 200 from axially sliding apart. The fixing member 300 may include the fixing ring 320.

Describing the fixing member 300 in more detail, the fixing member 300 include the fixing ring 320, wherein the ring shaped base 322 of the fixing ring 320 may be fitted on the outer circumference of the first rotary shaft 100, and the insertions 324 may be inserted in the fixing apertures 400 formed to communicate with the exterior through the inner circumference of the second rotary shaft 200.

The fixing member 300 having the configuration described above may prevent the first rotary shaft 100 and the second rotary shaft 200 from axially sliding apart by positioning the base 322 between the support groove 120 and the mount groove 250, and the insertions 324 protruding from the base 322 may be inserted in the fixing apertures 400 to completely fix the fixing member 300 between the support groove 120 and the mount groove 250 to prevent the fixing member 300 from breaking due to a centrifugal force.

Further, the fixing apertures 400 may be formed through the circumference toward the center of the shaft and the fixing ring 320 may be made of synthetic resin injected in the fixing apertures 400. This configuration may remove the limitation of a manufacturing process wherein the fixing members 300 are formed on the outer circumference of the first rotary shaft 100 and then are fitted or inserted into the fixing apertures 400 of the second rotary shaft 200.

Further, the space between the support groove 120 of the first rotary shaft 100 and the mount groove 250 of the second rotary shaft 200 may be substantially filled with synthetic resin to form the fixing member 300, thus the space between the support groove 120 and the mount groove 250 may be removed. Therefore, as the space between the first rotary shaft 100 and the second rotary shaft 200 is filled with the fixing member 300, water or foreign substances that may flow into between the locking protrusions 110 and the locking grooves 210 may be blocked to prevent corrosion of the joints of the rotary shafts and to increase the coupling force of the first rotary shaft 100 and the second rotary shaft 200.

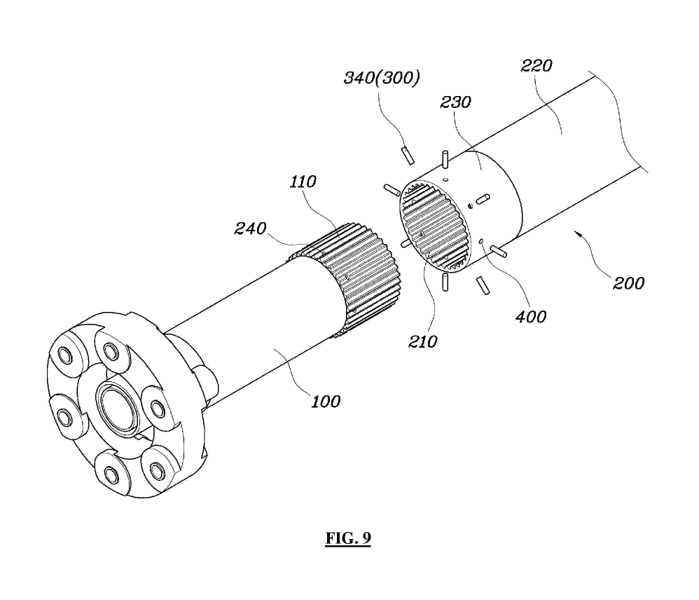

On the other hand, FIG. 9 is an exemplary view showing a drive shaft according to a second exemplary embodiment of the present invention, and the fixing members 300 may be fixing pins 340 that are fitted to the first rotary shaft 100 through the second rotary shaft 200 in claim 1. The fixing pins may be inserted in mount apertures 240 formed on the outer circumference of the first rotary shaft 100 and fixing apertures 400 formed axially through the second rotary shaft 200, corresponding to the mount apertures 240.

This configuration is another way of implementing a drive shaft of the present invention, in which the fixing members 300 may be fixing pins 340 fitted in the first rotary shaft 100 through the second rotary shaft 200. A plurality of fixing pins 340 may be formed along the circumference of the second rotary shaft 200 to be fitted in the first rotary shaft 100

Describing the configuration in more detail, the mount apertures 240 may be formed on the outer circumference of the first rotary shaft 100 and the fixing apertures 400 may be formed axially through the second rotary shaft 200, corresponding to the mount apertures 240. As the fixing pins 340 are fitted into the fixing apertures 400 communicating with the exterior of the second rotary shaft 200 from the mount apertures 240 formed at the first rotary shaft 100, the fixing pins 340 may fix the first rotary shaft 100 and the second rotary shaft 200 to prevent the shafts 100 and 200 from axially sliding apart.

The fixing pins 340 may be formed by injecting resin into the mount apertures 240 and the fixing apertures 400 that communicate with the exterior of the second rotary shaft from the first rotary shaft, or may be formed as separate pins and fitted into the apertures. It may be possible to manufacture a driveshaft selectively in accordance with manufacturing methods by varying the manufacturing process of the present invention, as described above.

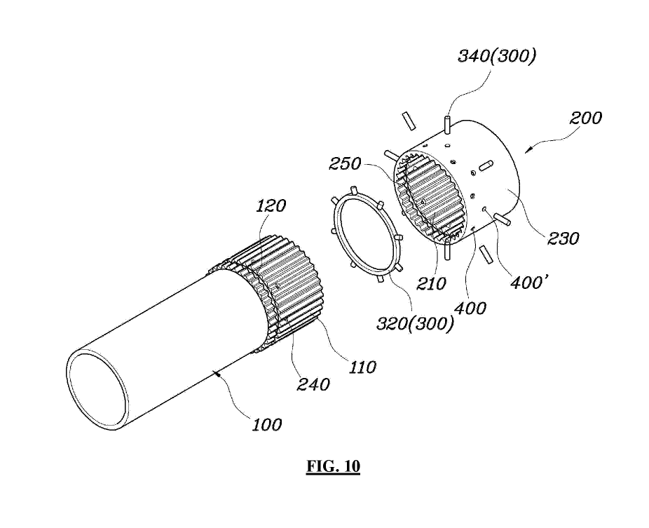

On the other hand, FIG. 10 shows another exemplary embodiment of the present invention, in which the fixing members 300 may be a fixing ring 320 disposed between the outer circumference of the first rotary shaft 100 and the inner circumference of the second rotary shaft 200 and the fixing pins 340 fitted in the first rotary shaft 100 through the second rotary shaft 200. In other words, it may be possible to combine the first embodiment with the second embodiment that are described above, or to use a plurality of the embodiments in various ways such as using the first embodiment as a pair or the second embodiment as a pair.

In detail, FIG. 10 shows an exemplary embodiment, in which the support groove 120 and the mount groove 250 facing each other may be formed on the outer circumference of the first rotary shaft 100 and on the inner circumference of the second rotary shaft 200, respectively, a fixing ring 320 may be inserted between the support groove 120 and the mount groove 250, fixing apertures 400′ may be formed with axially predetermined intervals on the second rotary shaft 200, and fixing pins 340 may be inserted into the mount apertures 240 formed on the outer circumference of the first rotary shaft 100, corresponding to the fixing apertures 400′ to prevent the first rotary shaft 100 and the second rotary shaft 200 from axially sliding apart.

Since a drive shaft of the present invention may be implemented in various ways, as described above, it may be possible to reinforce rigidity of the driveshaft by additionally using the respective embodiments, when axial rigidity is required further for the driveshaft, and it may be possible to improve passenger safety by adjusting the rigidity to be suitable with various vehicles. The fixing members 300 described above may be made of substantially light materials (e.g., materials that may break) such that they may break, when a predetermined amount or more of load is applied thereto due to a collision of a vehicle.

The first rotary shaft 100 and the second rotary shaft 200 may rotate together in a coupling status and may sufficiently absorb shock when being axially slid during a vehicle collision wherein the fixing members 300 may be configured to prevent the first rotary shaft 100 and the second rotary shaft 200 from sliding apart during operation of a vehicle (e.g., when a collision does not occur), and may be configured to allow the first rotary shaft 100 and the second rotary shaft 200 to break and slid during a vehicle collision.

When the fixing members 300 are made of a substantially soft material and break by a substantially small amount of shock, the first rotary shaft 100 and the second rotary shaft 200 may axially slide apart without a collision occurring. Further, when the fixing members 300 are made of a substantially soft material, they may generate resistance due to friction with the sliding rotary shafts after breaking. In contrast, when the fixing members 300 are made of a material having rigidity above a predetermined level, the fixing members 300 may not break during a vehicle collision, thus preventing the first rotary shaft 100 and the second rotary shaft 200 from sliding apart. Therefore, the fixing members 300 may be made of a substantially light material that allows the first rotary shaft 100 and the second rotary shaft 200 to slide apart while breaking by a predetermined amount of shock in a collision of a vehicle. On the other hand, the locking protrusions 110 of the first rotary shaft 100 and the locking grooves 210 of the second rotary shaft 200 may be formed in the shape of an involute gear which correspond to each other.

The first rotary shaft 100 and the second rotary shaft 200 of the present invention may transmit a rotary force by being engaged with the locking protrusions 110 and the locking grooves 210, and thus the shafts 100 and 200 may be formed in the shape of an involute gear. In general, an involute gear may be a structure advantageous to transmit a rotational force because the teeth of the gear have substantially high strength and are less influenced in engagement with another member. Accordingly, it may be possible to satisfy the advantageous condition to transmit a rotational force of the first rotary shaft 100 and the second rotary shaft 200 by ensuring substantially smooth transmission of the rotational force and torsional strength, with making the structures of the locking protrusions 110 and the locking grooves 210 in the shape of an involute gear.

On the other hand, the second rotary shaft 200 may include a bar shaped shaft body 220 and a hub 230 with a plurality of locking grooves 210 that mesh with the locking protrusions 110, on the inner circumference of an end portion of the shaft body 220. The second rotary shaft 200 may include the bar shaped shaft body 220 and the hub 230. Additionally, although it may be possible to form the locking grooves 210, which mesh with the locking protrusions 110, on the shaft body 220 of the second rotary shaft 200, the manufacturing process may be limited, the cost may increase, and there may be difficulty in accurate forming, when forming the locking grooves 210 corresponding to the locking protrusions 110 on the inner circumference, for the material and the structural features of the second rotary shaft 200. Therefore, it may be possible to reduce the cost and simplify the manufacturing process by separately forming the hub 230 with locking grooves 210 corresponding to the locking protrusions 110 on the inner circumference and by fixing the hub to the end portion of the shaft body 220.

According to a drive shaft having the structure described above, it may be possible to maintain torsional strength and flexural rigidity, which are the basic functions of a drive shaft, by including a first rotary shaft and a second rotary shaft, to reduce a shock transmitted to a vehicle body due to the axial length sufficiently changing by the first rotary shaft that is inserted into the second rotary shaft in a collision, and decrease passenger injury.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A drive shaft comprising:
a first rotary shaft having a plurality of locking projections allowing a spline engagement formed along an outer circumferential surface of an end portion of the first rotary shaft;
a secondary rotary shaft having a plurality of locking grooves for the spline engagement corresponding to the locking projections, wherein the plurality of locking grooves are formed on the inner circumferential surface into which the first rotary shaft is inserted;
one or more fixing members fitted on the outer circumference of the first rotary shaft or the inner circumference of the second rotary shaft; and
one or more fixing apertures formed through the outer circumference of the first rotary shaft to correspond to the fixing members and into which the fixing members are fitted,
wherein the first rotary shaft and the second rotary shaft are prevented from sliding apart by fitting the fixing members into the fixing apertures, and when load is applied due to a vehicle collision, the fixing members break, to allow the first rotary shaft and the second rotary shaft to slide apart.

2. The drive shaft of claim 1, wherein the fixing members are a fixing ring disposed between the outer circumference of the first rotary shaft and the inner circumference of the second rotary shaft.

3. The drive shaft of claim 2, wherein the fixing ring has a ring shaped base and includes a plurality of insertions protruding with predetermined intervals along the circumference of the base.

4. The drive shaft of claim 2, wherein a support groove and a mount groove facing each other are formed on the outer circumference of the first rotary shaft and the inner circumference of the second rotary shaft, respectively, and the fixing ring is disposed between the support groove and the mount groove.

5. The drive shaft of claim 2, wherein the fixing apertures are formed through the circumference of the second rotary shaft toward the center of the drive shaft and the fixing ring is made of synthetic resin injected into the fixing apertures.

6. The drive shaft of claim 1, wherein the fixing members are fixing pins fitted to the first rotary shaft through the second rotary shaft.

7. The drive shaft of claim 6, wherein the mount apertures are formed on the outer circumference of the first rotary shaft, the fixing apertures are formed axially through the second rotary shaft, corresponding to the mount apertures, and the fixing pins are inserted into the mount apertures and the fixing apertures.

8. The drive shaft of claim 1, wherein the fixing member includes:
a fixing ring disposed between the outer circumference of the first rotary shaft and the inner circumference of the second rotary shaft; and
a plurality of fixing pins fitted to the first rotary shaft through the second rotary shaft.

9. The drive shaft of claim 1, wherein the fixing member is made of a material configured to break when a predetermined amount of load is applied due to a vehicle collision.

10. The drive shaft of claim 1, wherein the locking protrusions of the first rotary shaft and the locking grooves of the second rotary shaft are formed in the shape of an involute gear.

11. The drive shaft of claim 1, wherein the second rotary shaft has a bar shaped shaft body and a hub having a plurality of locking grooves configured to mesh with the locking protrusions, on the inner circumference of an end portion of the shaft body.

12. A drive shaft comprising:
a first rotary shaft having a plurality of locking projections allowing a spline engagement formed along an outer circumferential surface of an end portion of the first rotary shaft;
a secondary rotary shaft having a plurality of locking grooves for the spline engagement corresponding to the locking projections, wherein the plurality of locking grooves are formed on the inner circumferential surface into which the first rotary shaft is inserted;
one or more fixing members fitted on the outer circumference of the first rotary shaft or the inner circumference of the second rotary shaft; and
one or more fixing apertures formed through the inner circumference of the second rotary shaft to correspond to the fixing members and into which the fixing members are fitted,
wherein the first rotary shaft and the second rotary shaft are prevented from sliding apart by fitting the fixing members into the fixing apertures, and when load is applied due to a vehicle collision, the fixing members break, to allow the first rotary shaft and the second rotary shaft to slide apart.

13. The drive shaft of claim 12, wherein the fixing members are a fixing ring disposed between the outer circumference of the first rotary shaft and the inner circumference of the second rotary shaft.

14. The drive shaft of claim 13, wherein the fixing ring has a ring shaped base and includes a plurality of insertions protruding with predetermined intervals along the circumference of the base.

15. The drive shaft of claim 13, wherein a support groove and a mount groove facing each other are formed on the outer circumference of the first rotary shaft and the inner circumference of the second rotary shaft, respectively, and the fixing ring is disposed between the support groove and the mount groove.

16. The drive shaft of claim 13, wherein the fixing apertures are formed through the circumference of the second rotary shaft toward the center of the drive shaft and the fixing ring is made of synthetic resin injected into the fixing apertures.

17. The drive shaft of claim 12, wherein the fixing members are fixing pins fitted to the first rotary shaft through the second rotary shaft.

18. The drive shaft of claim 17, wherein the mount apertures are formed on the outer circumference of the first rotary shaft, the fixing apertures are formed axially through the second rotary shaft, corresponding to the mount apertures, and the fixing pins are inserted into the mount apertures and the fixing apertures.

19. The drive shaft of claim 12, wherein the fixing member includes:
a fixing ring disposed between the outer circumference of the first rotary shaft and the inner circumference of the second rotary shaft; and
a plurality of fixing pins fitted to the first rotary shaft through the second rotary shaft.
